(19) United States
(12) Patent Application Publication
(10) Pub. No.: US 2005/0092959 A1
(43) Pub. Date: May 5, 2005

(54) Slide valve

(76) Inventors: Sven Busch, Dortmund (DE); Thomas Salutzki, Witten (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/502,862

(22) PCT Filed: Jun. 24, 2003
(86) PCT No.: PCT/EP03/06618

(30) Foreign Application Priority Data
Jun. 27, 2002 (DE) 10228871.2

(51) Int. Cl. F16K 1/00

(52) U.S. Cl. 251/324

(57) ABSTRACT

The invention is directed to a slide valve with a valve body (1) and a throttle body (2) which is mounted at the valve body (1). In order to provide a slide valve which ensures good tightness while also reducing expenditure on manufacturing and which can therefore be produced more economically, the throttle body (2) according to the invention is provided with a slit (3) extending in axial direction thereof.

The invention is directed to a slide valve with a valve body and a restrictor or throttle body which is mounted at the valve body.

Slide valves of the type mentioned above are sufficiently well known in the prior art, e.g., from DE 42 41 701 C1. In order to ensure good tightness in slide valves of this kind, the throttle body and the valve seat must be manufactured with great precision. This is time-consuming and therefore expensive.

Accordingly, it is the object of the present invention to provide a slide valve which ensures good tightness while also reducing expenditure on manufacturing and which can therefore be produced more economically.

This object is met through the features indicated in patent claim 1. Advantageous further developments follow from the subclaims.

A two-part slide valve is made of metal and the throttle body is made of plastic. The throttle body has a cylindrical shape and plugs into a guide bore hole. A transverse bore hole through which a volume flow passes is closed entirely or only partially depending upon the adjusted position, i.e., depending upon the direction in which the slide valve is turned.

The slide valve according to the invention can ensure good tightness while being produced in a substantially more economical manner. This is due to the fact that the slit allows the throttle body to deform elastically in circumferential direction so that it can tightly contact the valve seat and so that requirements with respect to the tolerances of the throttle body need not be too exacting. Due to the excellent elasticity of the throttle body, tilting in the valve seat can also be prevented, so that the slide valve according to the invention also affords improved functionality in addition to low manufacturing costs. According to an advantageous further development, the throttle body is constructed substantially as a slit hollow cylinder. This geometric shape is simple to produce and also does not make greater demands on the valve seat with respect to its shaping, so that this measure contributes overall to a more economical production.

The throttle body is preferably made of a flexible material in order to achieve good tightness. This ensures a tight contact between the throttle body and the valve seat.

According to a preferred further development, the throttle body is overdimensioned in relation to a valve seat receiving the throttle body. In this way, the throttle body which is inserted in the valve seat is positively deformed in a simple manner and can accordingly tightly contact the valve seat.

In order that the throttle body can be inserted easily into the valve seat, the valve seat, according to the invention, has a bevel on its side facing the valve body.

An especially tight and exactly fitting contact of the throttle body in the valve seat is achieved in a preferred further development in that the throttle body can be compressed by the valve seat in such a way that the slit of the throttle body is completely closed or almost completely closed in the inserted state. In order to fasten the throttle body to the valve body in a simple manner, the throttle body is held at the valve body by a snap connection according to an advantageous construction. A snap connection of this kind is simple to produce but nevertheless ensures that the throttle body and valve body are held together securely with increased holding force.

In order to facilitate the snap-in connection, the valve body in an advantageous further development has a projection in the shape of a truncated cone or frustum at its end facing the throttle body.

The frustum-shaped projection is preferably provided with an undercut. This makes it possible for the throttle body to be supported securely at the valve body.

In order to achieve a secure connection with the undercut, the throttle body in a preferred construction is provided at its end facing the valve body with an annular bead which faces inward and which engages in the undercut. It is ensured in this way that the throttle body can be supported without play at the valve body.

According to an advantageous further development, the slit in the throttle body also extends through the annular bead. Therefore, on the one hand, the frustum-shaped projection at the valve body can easily expand the slit throttle body during assembly until the annular bead comes to rest in the undercut and, on the other hand, it can be ensured that the throttle body deforms easily in the valve seat.

Other features and advantages of the invention are indicated in the following description of a preferred embodiment example.

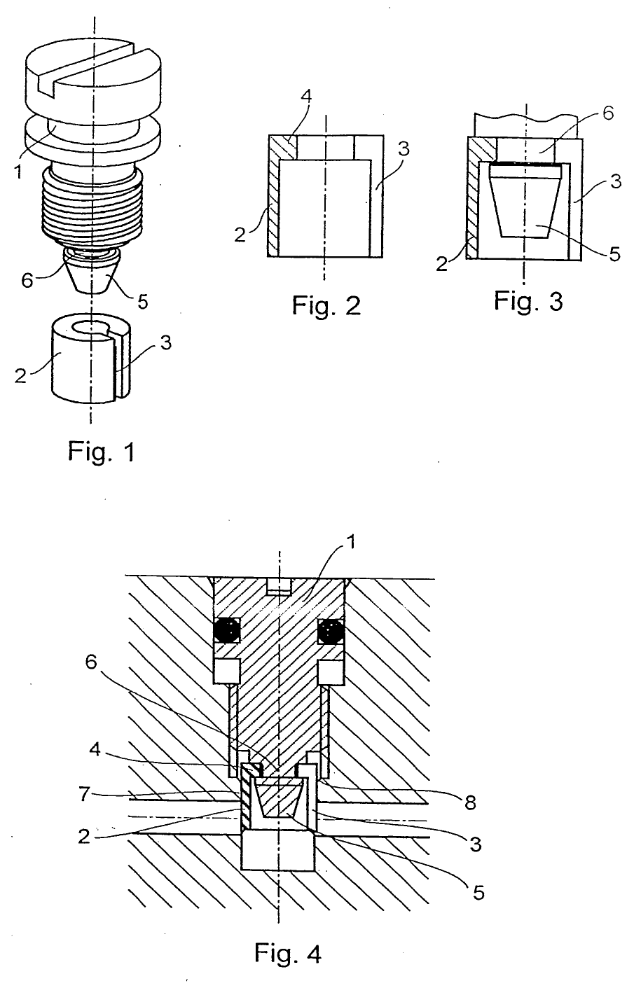

FIG. 1 shows the slide valve according to the invention with valve body and throttle body;

FIG. 2 shows a section through the throttle body according to the invention;

FIG. 3 shows a section through the lower part of the valve body with the throttle body inserted;

FIG. 4 shows a section through the slide valve inserted into a housing.

A slide valve according to the invention is shown and described in FIGS. 1 to 4 with reference to a preferred embodiment example.

FIG. 1 shows the slide valve according to the invention in disassembled state. A thread which cooperates with an internal thread inside a guide bore hole is provided for adjusting the slide valve. A seal extends radially around a head, not shown in more detail, for adjusting the slide valve. A valve body 1 and a substantially hollow-cylindrical throttle body 2 which is separate from the valve body 1 are shown. The throttle body 2 is provided with a slit 3 which extends in axial direction thereof over the entire height of the throttle body 2. At its end facing the valve body 1, the throttle body 2 is provided with an annular bead 4 facing inward (see FIG. 2). This annular bead 4 is likewise slit. However, it is also possible that the annular bead 4 is not provided with the slit 3.

The valve body 1 is provided at its end facing the throttle body 2 with a frustum-shaped projection 5 whose thinner end is directed to the throttle body 2. The frustum-shaped projection 5 is provided at its thicker end with an undercut 6 in which the annular bead 4 of the throttle body 2 engages when the throttle body 2 is secured to the valve body 1.

The throttle body 2 is mounted in a valve seat 7 so as to be movable back and forth. In order that the throttle body 2, which is fashioned so as to be overdimensioned in relation to the valve seat 7, can be inserted easily into the valve seat 7, the valve seat 7 is provided with a bevel 8 at its end facing the throttle body 2 and valve body 1. This bevel 8 also facilitates the elastic deformation of the throttle body 2 when inserting into the valve seat 7.

The preceding description of the embodiment example of the present invention is intended only for illustrative purposes and not to limit the invention. Various changes and modifications are possible within the framework of the invention without departing from the scope of the invention or its equivalents. A slide valve of the type described above can be put to use wherever valves are required. This applies in particular to hydraulic door closers and rotating sash drives.

In addition to the advantages of easy assembly, excellent holding force of the snap connections and high elasticity of the throttle body 2, which affords good tightness and prevents jamming in the guide bore hole, the slide valve is characterized by excellent stability with respect to temperature. The temperature stability improves as the throttle path or throttle gap length decreases.

Reference Numbers

1 valve body
2 throttle body
3 slit
4 annular bead
5 frustum-shaped projection
6 undercut
7 valve seat
8 bevel

1. A slide valve with a valve body and a throttle body which is mounted at the valve body, wherein the throttle body (2) is provided with a slit (3) extending in axial direction thereof.

2. A slide valve according to claim 1, wherein the throttle body (2) is constructed substantially as a slit hollow cylinder.

3. A slide valve according to claim 1, wherein the throttle body (2) is made of a flexible material.

4. A slide valve according to claim 1, wherein the throttle body (2) is overdimensioned in relation to a valve seat (7) receiving the throttle body (2).

5. A slide valve according to claim 1, wherein the valve seat (7) has a bevel (8) on its side facing the valve body (1).

6. A slide valve according to claim 1, wherein the throttle body (2) can be compressed by the valve seat (7) in such a way that the slit (3) of the throttle body (2) is completely closed or almost completely closed in the inserted state.

7. A slide valve according to claim 1, wherein the throttle body (2) is held at the valve body (1) by a snap connection.

8. A slide valve according to claim 1, wherein the valve body (1) has a frustum-shaped projection (5) at its end facing the throttle body (2).

9. A slide valve according to claim 1, wherein the frustum-shaped projection (5) is provided with an undercut (6).

10. A slide valve according to claim 1, wherein the throttle body (2) is provided at its end facing the valve body (1) with an annular bead (4) which faces inward and which engages in the undercut (6).

11. A slide valve according to claim 1, wherein the slit (3) in the throttle body (2) also extends through the annular bead (4).
